(19) United States
(12) Patent Application Publication
(10) Pub. No.: US 2016/0036951 A1
(43) Pub. Date: Feb. 4, 2016

(54) PROTECTIVE CASE FOR MOBILE DEVICE WITH INTEGRATED MOUNTING SYSTEM

(71) Applicant: Morteza Hamidi, Laguna Hills, CA (US)

(72) Inventor: Morteza Hamidi, Laguna Hills, CA (US)

(21) Appl. No.: 14/447,367

(22) Filed: Jul. 30, 2014

(51) Int. Cl. H04M 1/04; H04B 1/3888

(52) U.S. Cl. CPC H04M 1/04; H04B 1/3888; B60R 11/0241

(57) ABSTRACT

The invention generally relates to a system for mounting a phone, perhaps on a vehicle's dashboard. The system may comprise a mounting device and a protective phone cover, wherein the mounting device and protective phone cover may be mated with one another via a plurality of adhesive members, exemplarily one employing a separable fastener like VELCRO®. In one embodiment, the mounting device may be a surface clip which clamps down onto a dashboard or other surface and allows for a mobile device such as a mobile phone to be adhered to it to allow for robust, unhindered functionality. In another embodiment, the mounting device may rest on top of a dashboard or other surface and may make use of an adhesive member to adhere to the surface top and provide a secure means of subsequently attaching a mobile device.

### TECHNICAL FIELD OF THE INVENTION

The present invention relates in general to a carrying case and mount system for mobile devices, and more specifically, to a system for conveniently mounting a mobile device to a surface such as a dashboard of a vehicle.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

While operating a vehicle, it can be distracting, dangerous, and sometimes even illegal to use a mobile phone. Some newer models of vehicles have addressed this concern in part by allowing a user to sync their phone via Bluetooth® or other similar technology to a touch-screen display within the vehicle. Though helpful, this feature is typically limited to aiding in the dialing or sending and receiving of phone calls and perhaps text messages. Thus, the display will likely not be able to present a set of directions, a list, GPS maps, or any number of other features. Thus, a user who, for instance, wishes to be able to see the map generated by a GPS application on his or her smartphone, may be forced to handle the phone while driving, impeding the user's ability to remain focused on their surroundings. A setup wherein the functionality of a phone is achievable without incurring many of the risks associated with distracted driving would be an ideal compromise. Therefore, in light of the problems presented by the prior art, there is a need in the art for a system for mounting a phone within a vehicle, allowing for ease of installation and subsequent access as well as robust functionality, and affording many of the safety benefits associated with built-in touch screen displays for vehicles. It is to these ends that the present invention has been developed.

### BRIEF SUMMARY OF THE INVENTION

To minimize the limitations in the prior art, and to minimize other limitations that will be apparent upon reading and understanding the present specification, the present invention describes a system for mounting a mobile device to a surface- or a carrying case and mount system for mobile devices that conveniently enables mounting a mobile device to a surface, such as a dashboard of a vehicle.

A system for mounting a phone, in accordance with one embodiment of the present invention, comprises: a mounting device with a first adhesive member, for attaching to a surface; and a phone cover removably coupled to the mounting device, wherein the phone cover comprises a recess roughly centrally located along the back of the phone cover, and wherein the recess comprises a second adhesive member configured to mate with the first adhesive member.

A phone cover for coupling to a mounting device, in accordance with one embodiment of the resent invention, comprises: a main body, for supporting a phone; a recess roughly centrally located along a back surface of the main body; and a first adhesive member, housed within the recess, and configured to mate with a second adhesive member of a mounting device.

A system for mounting a phone, in accordance with another embodiment of the present invention, comprises: a mounting device with a protruding member, the protruding member configured to support a first separable fastener; and a phone cover removably coupled to the mounting device, comprising: a main body, for housing a phone; a recess roughly centrally located along a back surface of the phone cover, the recess comprising a second separable fastener, wherein the recess is configured to mate with the protruding member via the first and second separable fasteners; a recess cover, for concealing and protecting the second adhesive member; and a pocket, beneath the main body, for housing the recess cover.

It is an objective of the present invention to provide a quick and convenient means of installing a mobile device mount into a vehicle or other surface.

It is another objective of the present invention to permit substantially unadulterated access to a user's mobile device whilst operating the vehicle.

It is yet another objective of the present invention to provide a means to move and remove a phone mount and or phone based on where and whether it is needed at any particular time.

It is yet another objective of the present invention to provide a cover for a mobile device, which may comprise an adhesive member for mating to a mounted component on a surface.

Finally, it is yet another objective of the present invention to provide a cover for a mobile device which has the ability to shield an attached adhesive member from collecting various miscellany and hurting the efficacy or aesthetics of said adhesive member.

These and other advantages and features of the present invention are not meant as limiting objectives, and are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of the various embodiments of the invention. Furthermore, elements that are known to be common and well understood to those in the industry are not depicted in order to provide a clear view of the various embodiments of the invention. The drawings that accompany the detailed description can be briefly described as follows:

FIG. 1(a) depicts a phone securing system for use in a vehicle, in accordance with an exemplary embodiment of the present invention.

FIG. 1(b) depicts a surface clip for receiving a phone, in accordance with an exemplary embodiment of the present invention.

FIG. 2(a) depicts a phone securing system for use in a vehicle, in accordance with another exemplary embodiment of the present invention.

FIG. 2(b) depicts a dashboard stand for receiving a phone, in accordance with an exemplary embodiment of the present invention.

FIG. 3(a) depicts a phone cover comprising an adhesive material housed within a recess roughly in the shape of a rectangle, in accordance with an exemplary embodiment of the present invention.

FIG. 3(b) is a side view of the phone cover in FIG. 3(a), in accordance with an exemplary embodiment of the present embodiment.

FIG. 4(a) depicts a phone cover similar to one displayed in FIG. 3(a), further equipped with a cover for the adhesive material, in accordance with another exemplary embodiment of the present invention.

FIG. 4(b) is a side view of the phone cover in FIG. 4(a), wherein the phone cover employs an optional cover to protect and conceal the adhesive material, in accordance with an exemplary embodiment of the present invention.

FIG. 4(c) is a side view of the phone cover in FIGS. 4(a) and 4(b), showing the cover for the adhesive material in a closed position.

### DETAILED DESCRIPTION OF THE INVENTION

In the following discussion that addresses a number of embodiments and applications of the present invention, reference is made to the accompanying figures that forms a part thereof, where depictions are made, by way of illustration, of specific embodiments in which the invention may be practiced. It is to be understood that other embodiments may be utilized and changes may be made without departing from the scope of the present invention.

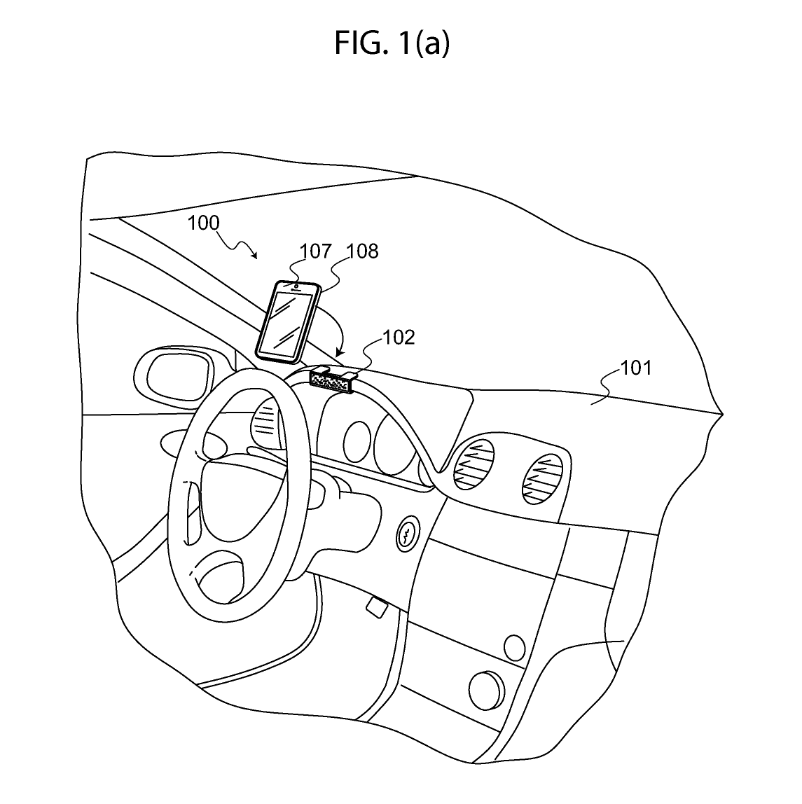

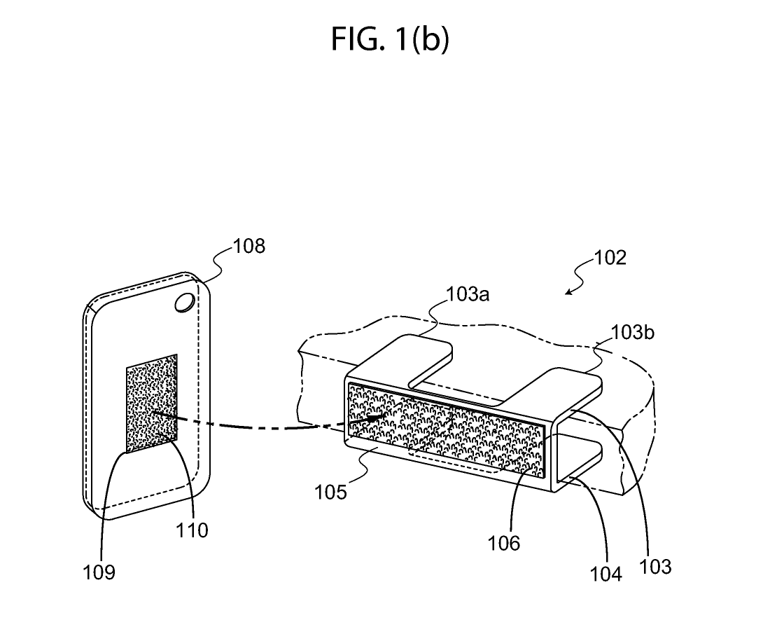

FIG. 1(a) depicts a phone securing system for use in a vehicle, in accordance with an exemplary embodiment of the present invention. As seen in FIG. 1(a) and FIG. 1(b), system 100 interacts with dashboard 101 and comprises mounting device or surface clip 102 and protective cover 108. Surface clip 102 further comprises first fastening member 103, second fastening member 104, adhesive face 105, and adhesive member 106. As seen in FIG. 1(a), protective cover 108 is secured to mobile device 107 and may be removably coupled to surface clip 102 by adhering to adhesive member 106. Furthermore, protective cover 108 comprises recess 109 and adhesive member 110.

System 100 represents an exemplary embodiment of the present invention, wherein a phone such as mobile device 107 may be secured to a surface, for example to dashboard 101, to allow for the front face of the phone to be conveniently propped up in view of a user. Such a setup may be useful in times wherein substantially hands-free communication is mandated or recommended, most notably whilst a user is operating a vehicle. It will be understood that system 100 may be implemented on any number of different surfaces. For instance, and without deviating from the scope of the present invention, system 100 may be implemented on a table, desk, or keyboard tray. Thus, system 100 may more broadly be incorporated on any compatible surface wherein such incorporation may support, suspend, or prop up a phone, phablet, tablet or other mobile device.

Dashboard 101, with reference to FIG. 1(a), is a motor vehicle dashboard and serves as a recipient of system 100. A vehicle (and its dashboard) is an exemplary choice for such as a system, as being able to answer calls, utilize global positioning systems (GPS), and the like while driving may be desirable tasks. However, it should be understood that any other surface may be a suitable surface recipient of system 100, including without limitation a center console, side panel, or any other surface suitable for receiving surface clip 102. Furthermore, other surfaces outside of a vehicle may be appropriate for placing a mounting device in accordance with the present invention.

Surface clip 102 is an element of system 100 which, in FIG. 1(a), conveniently clips onto or straddles dashboard 101 so as to provide a stable and secure means of attaching a phone or other mobile device. This fastening action may be accomplished through use of fastening members such as first fastening member 103 and second fastening member 104. In one exemplary embodiment, first fastening member 103 clamps down atop dashboard 101 and a second fastening member 104 would clamp down on the underside of dashboard 101.

As shown, first fastening member 103 and any other fastening member may comprise a plurality of claws, for instance claws 103a, 103b for contacting dashboard 101 or any other surface wherein surface clip 102 may be affixed. Fastening members on surface 102 such as first fastening member 103 may employ fewer or greater claws for contacting a surface such as dashboard 101 without deviating from the scope of the present invention. For example, first fastening member 103 may comprise three claws for providing frictional force on dashboard 101, perhaps one on each end and a third in the middle.

Claws 103a, 103b grab hold or clamp down atop the desired surface to provide stability to surface clip 102 and thereby a connected mobile device. Second fastening member 104 also comprises claws for grabbing hold or clamping down below the desired surface. With reference to FIG. 1(b), one such claw is visible, though two such claws are present as part of second fastening member 104.

With continued reference to FIG. 1(a)-(b), adhesive face 105 and adhesive member 106 are additional components of surface clip 102. Adhesive face 105 comprises adhesive member 106 and thus serves as the face of surface clip 102 wherein a mobile device, or more specifically, a mobile device's protective cover, may be affixed.

Adhesive face 105 may take a number of shapes without deviating from the spirit of the present invention. For instance, although adhesive face 105 is rectangular in shape in the present figure, it may also take the form of a square, circle, oval, triangle, or any other conceivable shape so long as surface clip 102 is not resultantly hindered from being affixed to a desired surface. Just as adhesive face 105 may take a number of shapes, so too may adhesive member 106. For example, adhesive member 106 may take the form of a square, circle, oval, triangle, or any other conceivable shape.

Adhesive member 106 serves to adhere one component of system 100, surface clip 102, to another component of system 100, protective cover 108. This may occur through a number of different means, though in an exemplary embodiment, VELCRO® (VELCRO) is employed. Additionally, any hook and loop fastener material or separable fastener may be employed without deviating from the spirit or scope of the present invention. The specifics related to the functionality of hook and loop fasteners or any separable fastener, including but not limited to VELCRO, would be known and understood by a person of ordinary skill in the art.

Alternatively, other common adhesives that would be known by a person of ordinary skill in the art may be employed. In an exemplary embodiment, when adhered to protective cover 108, adhesive member 106 becomes entirely hidden from view such that the phone, for instance mobile device 107, is unobstructed and fully usable by a vehicle occupant.

In an exemplary embodiment, mobile device 107 is a smartphone. Additionally, mobile device 107 may be any type of mobile device, which can accommodate an adhesive backing for mating with adhesive member 106 of surface clip 102 or any alternative mounting device besides surface clip 102. Furthermore, mobile device 107 may be any mobile device which, like a mobile phone, may benefit from unobstructed visibility and ease of access while driving. For instance, mobile device 107 may be a walkie-talkie, pager, mobile phone, phablet, tablet, or the like.

Protective cover 108 serves as a protective cover, carrying case or backing for mobile device 107 and exemplarily comprises an adhesive member of its own (not shown in FIG. 1(a)) to mate with adhesive member 106 of surface clip 102. Protective cover 108 may in principal be any type of cover which is capable of affording a degree of protection for a mobile device against physical damage. In an exemplary embodiment, protective cover 108 is a phone cover, used to protect mobile phones, smartphones, and the like. Similar to the previous discussion regarding the shape or form of adhesive member 106 of surface clip 102, the adhesive member exemplarily attached in some fashion to protective cover 108 may be any number of shapes. In an exemplary embodiment, the adhesive member attached to protective cover 108 may take the form of a square, circle, oval, triangle, or any other conceivable shape so long as such a shape does not resultantly hinder affixation to adhesive member 106.

Furthermore, protective cover 108 may be designed such that in the portions of its body wherein an adhesive member such as VELCRO is incorporated, protective cover 108 may indent, recess, or protrude from the rest of the cover's body. Such a configuration is discussed in greater specificity in later figures.

Recess 109 serves as a means of protecting and concealing adhesive member 110 from damage and exposure to the surrounding environment. In an exemplary embodiment, adhesive member 110, housed within recess 109, mates with adhesive member 106 of surface clip 102. A more detailed discussion of recess 109 and other similar embodiments comprising a recess is present in later figures.

FIG. 1(b) depicts a mounting device or surface clip for receiving a phone, in accordance with an exemplary embodiment of the present invention. As shown, surface clip 102 comprises first fastening member 103, second fastening member 104, a dashboard face (not shown), and an adhesive face 105. The dashboard face is, with respect to FIG. 1(b), meant to be construed as the face of surface clip 102 that is on the opposite side of adhesive face 105.

First and second fastening members 103, 104 may exemplarily have each of their one or more claws oriented perpendicular to the dashboard face or slightly inward-facing towards the dashboard face. In the latter case, first and second fastening members 103, 104 may then be better able clamp down onto the surface they together straddle, thus providing greater stability for the mobile device it may hold in place.

Without deviating from the scope of the present invention, surface clip 102 may comprise fewer or greater numbers of claws for gripping a surface than the two per fastening member shown in FIG. 1(b). For instance, in one embodiment, first fastening member 103 comprises just one claw which might extend along part of or the entire length of the dashboard face. Such alternatives may also exist for second fastening member 104 without deviating from the scope of the present invention.

Furthermore, in one embodiment, the claws which make up first and second fastening members 103, 104 may twist or be otherwise open to manipulation in order to more smoothly clip to and grip the desired surface. For instance, a dashboard often has a slight curve along its length and may benefit from surface clip 102 having a similar curve.

With respect to the present figure, adhesive face 105 may comprise adhesive member 106 for mating with an adhesive member of the mobile device cover, for instance a mobile phone cover. In an exemplary embodiment, when surface clip 102 is installed onto a car dashboard, adhesive face 105 and adhesive member 106 face towards the driver or passenger of the respective vehicle, such that the mobile phone may be mounted to surface clip 102 via the adhesive member present on the phone cover.

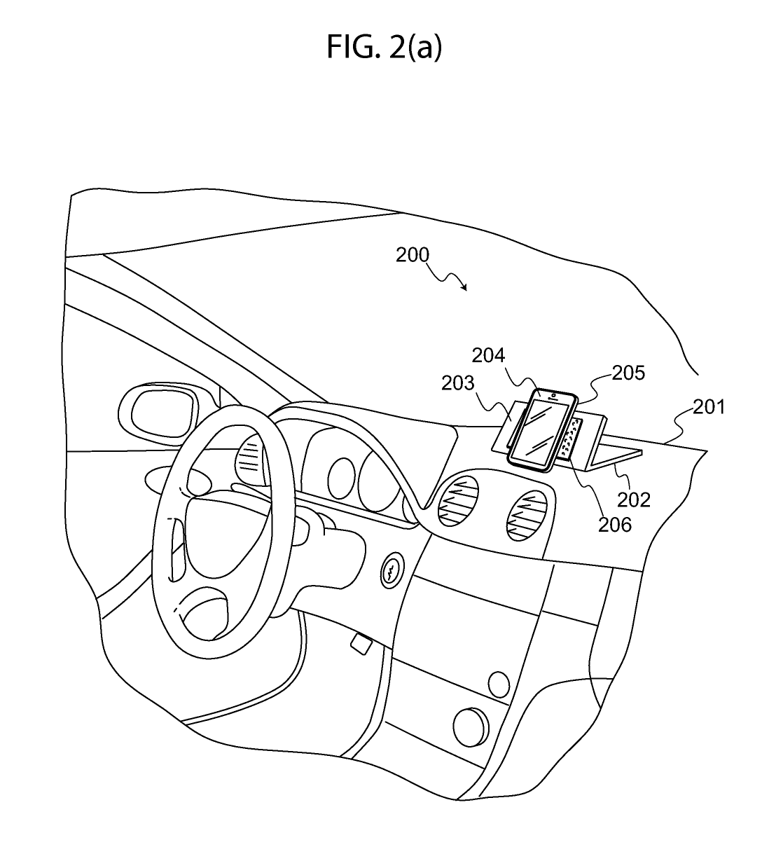

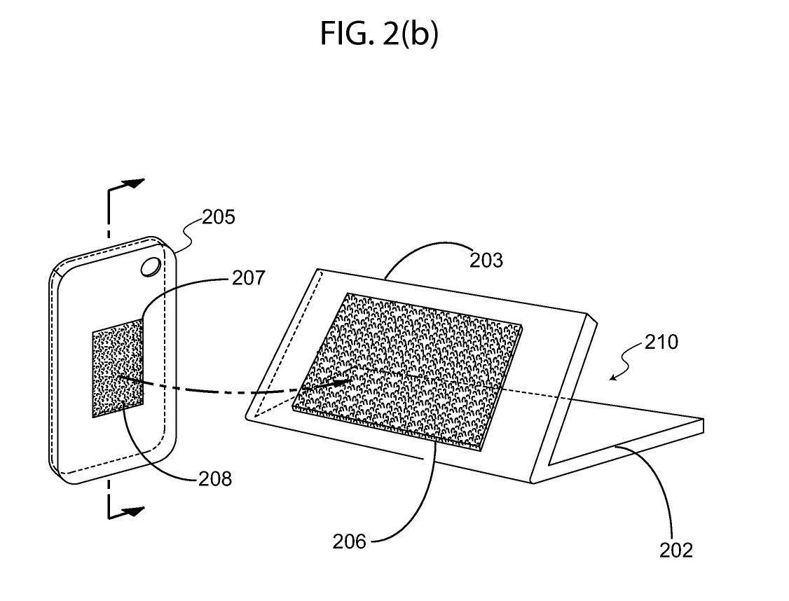

FIG. 2(a) depicts a phone securing system for use in a vehicle, in accordance with another exemplary embodiment of the present invention. As seen in FIG. 2(a), system 200 interacts with dashboard 201 and comprises dashboard face 202, adhesive face 203, and protective cover 205, which may be a protective carrying case for a mobile device such as mobile device 204. Adhesive face 203 comprises adhesive member 206 and also removably comprises phone 204 and its protective cover 205. Dashboard face 202 and adhesive face 203 together make up mounting device or surface stand 210. System 200 represents an exemplary embodiment of the present invention, wherein a mobile device such as phone 204 may be secured to a surface, for example to the top of a car dashboard 101, to allow for the front face of the phone to be conveniently propped up in view of a user. In this respect, dashboard face 202 may more broadly be referred to as a surface face in that it is the face wherein contact is made with the desired surface.

Dashboard face 202 of surface stand 210 is where contact is made with the desired surface, in this case the top of a vehicle's dashboard. Resultantly, in an exemplary embodiment, dashboard face 202 is accompanied by an adhesive member such as VELCRO on the bottom of its face to adhere to the dashboard. Depending on the adhesive member, the dashboard, for instance dashboard 201, may also need to have VELCRO or another adhesive installed so that it may keep dashboard face 202 and system 200 in place while the vehicle is in motion. Of course, other adhesive means or attachment means may be incorporated without deviating from the scope of the present invention.

With respect to FIG. 2(a), dashboard face 202 is attached to adhesive face 203. Adhesive face 203 may take a number of shapes and sizes, depending on the shape and size necessitated or desired by the user. For instance, dashboard face 202 and or adhesive face 203 may be smaller or larger depending on the size of the mobile device used. To expand, a smartphone may utilize a smaller version or alternate shape of system 200 than would a tablet.

Phone (mobile device) 204 is exemplarily protected by protective cover 205 and may be adhered to adhesive member 206, as is the case in the present figure, via an adhesive member attached to protective cover 205.

System 200 may be desirable for securing a mobile device visibly above a vehicle's steering wheel. As a result, the user need not alter their gaze significantly to receive pertinent information from the mounted mobile device, for instance the user's smartphone. This further minimizes the danger and risk of looking at a mobile device while operating a moving vehicle. Furthermore, if system 200 is, in fact, implemented above (and thus behind) the steering wheel on the dashboard, a user's fingers are in close proximity to the mobile device, so accepting a call or message or otherwise interacting with the mobile device takes less time and is therefore less dangerous.

FIG. 2(b) depicts a mounting device or dashboard stand for receiving a phone, in accordance with an exemplary embodiment of the present invention. As shown in FIG. 2(a), the system depicted by FIG. 2(b) comprises phone cover 205 and surface stand 210. Surface stand 210 includes dashboard face 202, adhesive face 203, and adhesive member 206. Phone cover 205 includes recess 207 and phone adhesive member 208.

Protective cover 205 may be mated to adhesive face 203 via adhesive member 206 and phone adhesive member 208. Adhesive member 206 and phone adhesive member 208 may employ a hook and loop method of adhesion or any other type of removable fastening method. For example, and without deviating from the scope of the present invention, VELCRO or a VELCRO-like material may be employed to quickly and conveniently allow for adhesion of a phone cover to a mounting device.

In one exemplary embodiment, the surface areas of adhesive member 206 and phone adhesive member 208 may be substantially similar, such that when protective cover 205 and adhesive face 203 are mated, adhesive members 206, 208 are substantially hidden from view. Thus, completion of system 200 would require precise placement of protective cover 205 on adhesive face 203.

However, in the exemplary embodiment represented by FIG. 2(b), the surface areas of adhesive members 206, 208 may noticeably differ. In this and in similar embodiments, a user of system 200 would have more control over the location and orientation of the mounted phone. For instance, the user would be capable of placing the phone parallel or perpendicular to the length of adhesive face 203.

In another embodiment, dashboard face 202 and adhesive face 203 form between a 45 and 90 degree angle with one another. In an exemplary embodiment, this angle is roughly 75 degrees. At such an angle, the attached mobile device, perhaps a phone, would be presented to a user at a slight upward angle so as to accommodate the higher position of the user with respect to the mounting device.

In an exemplary embodiment, dashboard or surface face 202 comprises its own adhesive member for enabling a mating between surface stand 210 and dashboard 201 or any other surface. This adhesive member may be located on the underside of dashboard face 202 and may be any material used to adhere two objects or surfaces. In an exemplary embodiment, the adhesive member on dashboard face 202 employs a hook and loop method of adhesion, such as one seen in traditional VELCRO material.

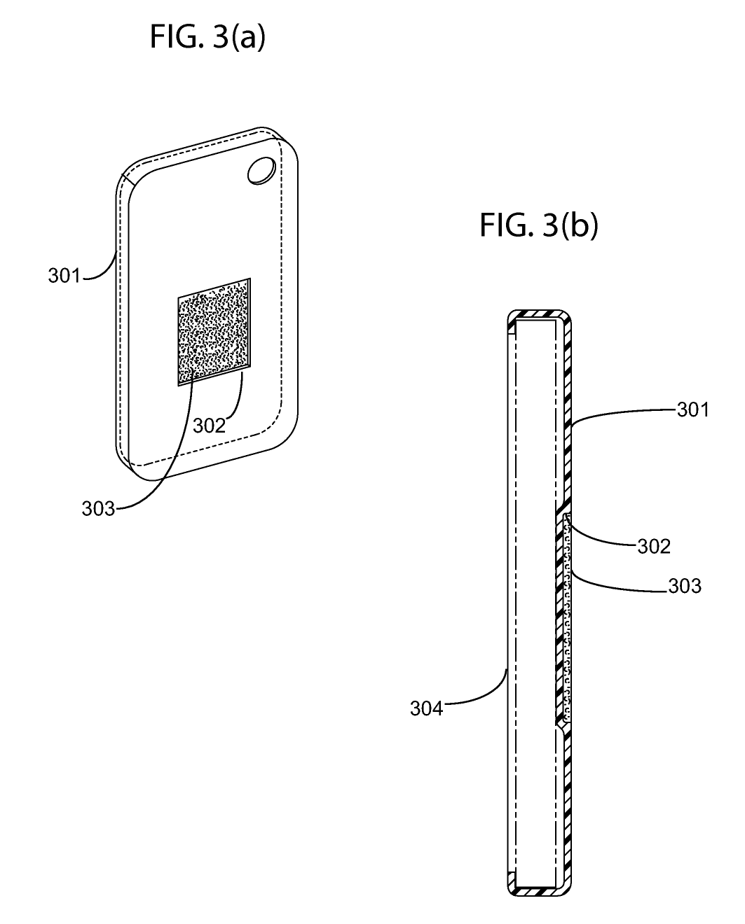

FIG. 3(a) depicts a phone cover comprising an adhesive material housed within a recess roughly in the shape of a rectangle, in accordance with an exemplary embodiment of the present invention. Phone cover 301 comprises recess 302 and adhesive member 303.

Phone cover 301 serves as the backing for a mobile phone to protect the phone from incurring significant damage. However, in an exemplary embodiment of the present invention, phone cover 301 may also serve an important supplementary purpose as a source of conveniently mounting a mobile phone within a vehicle or other desirable surface. Phone cover 301 may be accompanied by an adhesive member such as adhesive member 303 such that it is capable of mating with a member adhered to the desired surface.

Recess 302 of phone cover 301 serves as an indentation which permits more precise, reliable, and secure adhesion to a complimentary protruding member that may exist on, for example, system 100 or system 200. Thus, with respect to FIG. 3(a), recess 302 is exemplarily shaped like a recessed rectangle and may be mated to a substantially opposite protruding rectangle present on the surface clip, dashboard face, or the like. Naturally, and as is illustrated by subsequent figures, other shapes for the recess may exist. For example, the recess may take the form of a circle, ellipse, triangle, or any other conceivable shape.

In an exemplary embodiment of the present invention, recess 302 or any recess described herein may be centrally located on the protective phone cover with respect to either the length or width of the cover, perhaps though not necessarily both. This may help secure and balance the weight of the phone and lessen the stress placed on the phone cover's adhesive member.

Recess 302 may mitigate problems that can arise when adhesives frequently coming into contact with loose miscellany such as lint, hair, or the like. For instance, without recess 302, upon removing a mobile phone from a user's pockets, lint lining the inside of the pocket may adhere itself to the adhesive member, for instance VELCRO. Aside from being untidy and unsightly, such an occurrence may over time decrease the efficacy of the adhesive member and therefore the efficacy of the entire mobile device mounting system. By implementing a recess to house the adhesive member, lint, hair, or other miscellany are far less likely to bond to the adhesive member, improving both durability and efficacy.

Adhesive member 303 is housed within recess 302 and aids in the mating of phone cover 301 to a mounting member that is itself adhered in some fashion to a vehicle dashboard or other surface. As has been previously discussed, in two separate exemplary embodiments, the mounting member may take the form of a clip or a surface top mount. However, it will be understood that alternatives to the two exemplary embodiments are possible, and such alternative embodiments fall within the spirit and scope of the present invention.

FIG. 3(b) is a side view of the phone cover in FIG. 3(a), in accordance with an exemplary embodiment of the present embodiment. Phone cover 301 comprises recess 302, and recess 302 houses adhesive member 303. In the displayed embodiment, adhesive member 303 is substantially flush with the main body of phone cover 301, that is, the part of phone cover 301 covering the back of the phone, exempting recess 302. In addition to the main body of phone cover 301, a side body covering the sides of the phone and hooking around to the edges of the phone's front face is exemplarily employed to secure the phone in place. Main and side bodies of phone covers such as phone cover 301 would be known and understood by a person of ordinary skill in the art.

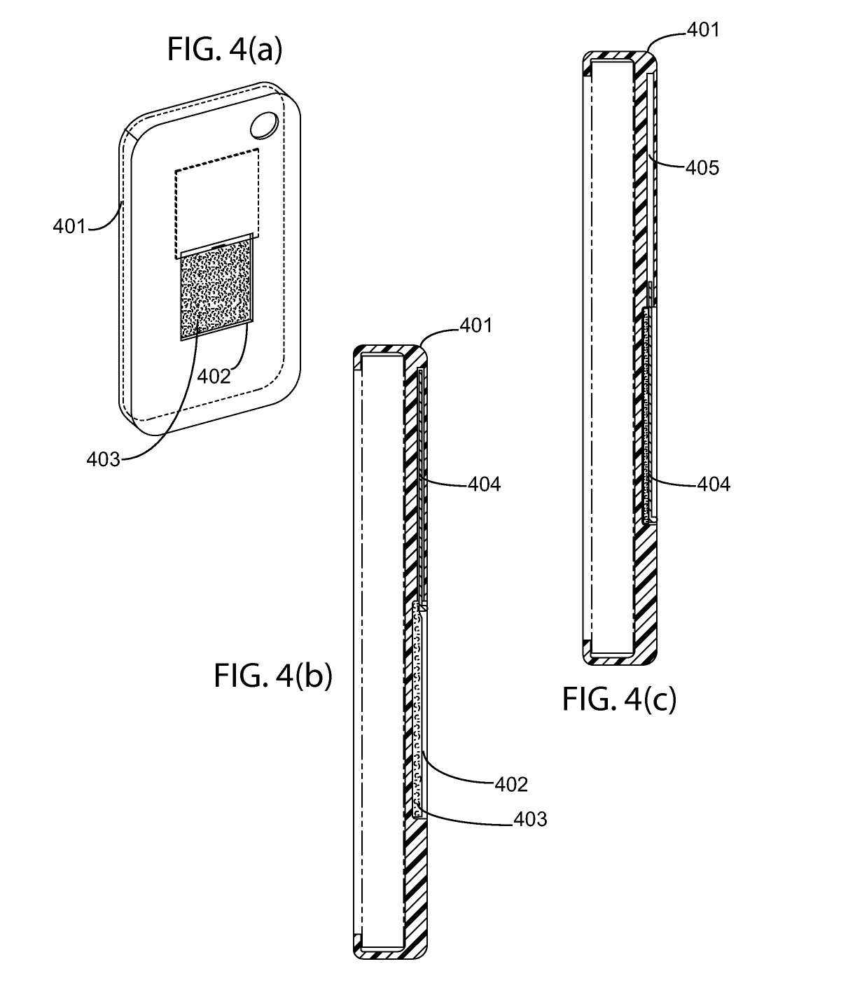

FIG. 4(a)-(c) depict a phone cover similar to the one displayed in FIG. 3(a), further configured with a cover for the adhesive material, in accordance with another exemplary embodiment of the present invention. Phone cover 401 comprises recess 402, adhesive member 403, and recess cover 404.

Much like the design described in the discussion pertaining to FIG. 3(a), phone cover 401 comprises recess 402, which is exemplarily a recess in the rough shape of a rectangle for protecting adhesive member 403 from unnecessary wear and tear and accumulation of small miscellany. Such wear and tear may come in the form of friction. For instance, in designs wherein an adhesive member is flush with or protrudes from a cover, friction with contacted surfaces may cause removal, tearing, or clogging of the adhesive member. To illustrate, if an adhesive member protrudes from a protective phone cover, upon a user removing their phone from a pants pocket, the adhesive member would likely rub against the pants lining, causing a disturbance of the integrity of the adhesive member or causing stray hair, lint, and other miscellany to adhere to the member and diminish its efficacy.

One potential solution to this problem is to incorporate a cover for the recess, such that when the adhesive member is not being used, it can be protected from exposure to outside elements. This cover may exemplarily come in the form of recess cover 404.

Recess cover 404 may be implemented atop adhesive member 403 flush or significantly flush with the back face of phone cover 401. Recess cover 404 serves a plurality of functions, the first of which is as a secondary protection against the discussed wear and tear and accumulation of small miscellany on adhesive member 403. For instance, when adhesive member 403 is not being used to mate phone cover 401 with the mounting device member, recess cover 404 may be slid to a closed position such that adhesive member 403 is hidden from view. Conversely, if a user for example wishes to set up a mobile phone to be mounted atop their vehicle's dashboard, recess cover 404 may, in an exemplary embodiment, be slid into an open position, revealing adhesive member 403 and allowing it to be mated to the mounting member.

It should be noted that although recess cover 404 is slid into position in the present embodiment, other such manners may be employed to reveal or hide adhesive member 403 that fall within the scope of the present invention. To illustrate, recess cover 404 may be snapped, clicked, twisted, or locked into place, among other such methods.

FIG. 4(b) is a side view of the phone cover in FIG. 4(a), wherein the phone cover employs an optional cover to protect and conceal the adhesive material, in accordance with an exemplary embodiment of the present invention. The design of phone cover 401 in FIG. 4(b) is similar to that of FIG. 3(b), with the notable exception that recess 402 is deeper than recess 302. The deepened recess of FIG. 4(b) permits addition of recess cover 404 as a component of phone cover 401, wherein the adhesive member 403 may be hidden from view and protected from contact when not in use so as to preserve adhesive member 403. In the presently discussed figure, recess cover 404 is not engaged, meaning adhesive member 403 remains exposed and visible, allowing it to mate with another adhesive member, perhaps an adhesive member of a mounting device such as the surface clip or surface stand discussed in previous figures.

FIG. 4(c) is a side view of the phone cover in FIGS. 4(a) and 4(b), showing cover 404 for adhesive member 403 in a closed position. FIG. 4(c) is identical to FIG. 4(b) with the exception that recess cover 404 is engaged, hiding adhesive member 403 from view. Thus, in an exemplary embodiment, adhesive member 404 is a detachable fastener such as VELCRO and, with recess cover 404 engaged, is unable to mate with an adhesive member of a mounting device. However, adhesive member 403 is protected from accumulation of unwanted miscellany.

Recess cover 404 may be implemented into phone cover 401 in a number of different ways. For example, phone cover 401 may, in one exemplary embodiment, be designed such that recess cover 404 may be hidden inside a pocket below the surface of phone cover 401's main body—for example, inside pocket 405. Recess cover 404 may be exposed or revealed by pulling on recess cover 404 and/or sliding recess cover 404 towards the far end of recess 402, concealing adhesive member 403 in the process. Thus, in an exemplary embodiment, recess cover 404 and pocket 405 are substantially dimensionally opposite. In this embodiment, both adhesive member 403 and recess cover 404 would reside below the surface of phone cover 401.

Due to the deepened recess seen in FIGS. 4(b) and 4(c), it may be helpful though not necessary for the adhesive member of the mounting device to be shaped in such a way that it better fits the dimensionality of the recess, thereby reaching down further and better contacting adhesive member 403 for enhanced adhesion. Thus, whereas recess 402 indents into phone cover 401, a mounting device for mating with phone cover 401 may exemplarily comprise a protruding member for fitting the indent of recess 402.

In one exemplary embodiment, recess 402 may substantially resemble an oval. In another exemplary embodiment, recess 402 may be any polygonal shape, including but not limited to, a rectangle, square, or triangle.

A mobile phone mounting system in accordance with the present invention enables a mobile device, such as a phone, to be secured to a surface, for example to dashboard of a car. This allows for the front face of the phone to be conveniently propped up in view of a user. Such a setup may be useful in times wherein substantially hands-free communication is mandated or recommended. Furthermore, a system in accordance with the present invention may be implemented on any number of different surfaces. For instance, and without deviating from the scope of the present invention, such a mounting system may be implemented on a table, desk, keyboard tray, or on any other suitable surface on which a user may desire to support, suspend, or prop up a phone, phablet, tablet or other mobile device.

A system for mounting a phone has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

1. A system for mounting a phone, comprising:
a mounting device with a first adhesive member, for attaching to a surface; and
a phone cover removably coupled to the mounting device, wherein the phone cover comprises:
a recess roughly centrally located along a back surface of the phone cover, wherein the recess comprises a second adhesive member configured to mate with the first adhesive member;
a pocket below the back surface of the phone cover and adjacent to the recess; and
a recess cover slidably housed within the pocket and situated beneath the back surface of the phone cover for concealing and protecting the second adhesive member.

2. The system of claim 1, wherein the mounting device comprises a protruding member configured to:
support the first adhesive member; and
mate with the recess on the back of the phone cover.

3. The system of claim 1, wherein the mounting device comprises:
a surface face, for attaching the mounting device to the surface; and
an adhesive face, for supporting the first adhesive member, wherein the adhesive face and the surface face form an angle between 45 and 90 degrees.

4. The system of claim 3, wherein the surface face comprises a third adhesive member for mating with the surface.

5. The system of claim 1, wherein the first and second adhesive members are separable fasteners.

6. The system of claim 1, wherein the mounting device comprises:
a first fastening member for providing frictional force on a first side of the surface;
a second fastening member for providing frictional force on a second side of the surface; and
an adhesive face connecting the first and second fastening members, wherein the adhesive face is configured to support the first adhesive member.

7. The system of claim 6, wherein the first and second fastening members are substantially perpendicular to the adhesive face.

8. The system of claim 6, wherein the first and second fastening members each comprise one or more claws.

9. (canceled)

10. (canceled)

11. The system of claim 1, wherein the shape of the recess is substantially polygonal.

12. The system of claim 1, wherein the shape of the recess is substantially an oval.

13. A phone cover for coupling to a mounting device, comprising:
a main body, for supporting a phone;
a recess roughly centrally located along a back surface of the main body;
a pocket below the back surface of the main body and adjacent to the recess;
a first adhesive member, housed within the recess, and configured to mate with a second adhesive member of a mounting device; and
a recess cover slidably housed within the pocket and situated beneath the back surface of the main body for concealing and protecting the first adhesive member.

14. (canceled)

15. (canceled)

16. The system of claim 13, wherein the shape of the recess is substantially polygonal.

17. The system of claim 13, wherein the shape of the recess is substantially an oval.

18. A system for mounting a phone, comprising:
a mounting device with a protruding member, the protruding member configured to support a first separable fastener; and
a phone cover removably coupled to the mounting device, comprising:
a main body, for housing a phone;
a recess roughly centrally located along a back surface of the main body, the recess comprising a second separable fastener, wherein the recess is configured to mate with the protruding member via the first and second separable fasteners;
a pocket below the back surface of the main body and adjacent to the recess; and
a recess cover, slidably housed within the pocket and situated beneath the back surface of the main body for concealing and protecting the second adhesive member.

19. The system of claim 18, wherein the mounting device comprises:
a first fastening member for providing frictional force on a first side of the surface;
a second fastening member for providing frictional force on a second side of the surface; and
an adhesive face connecting the first and second fastening members, wherein the adhesive face comprises the first separable fastener.

20. The system of claim 18, wherein the mounting device comprises:
a surface face, for attaching the mounting device to the surface, comprising a third separable fastener for mating with the surface; and
an adhesive face, for supporting the first separable fastener, wherein the adhesive face and the surface face form an angle between 45 and 90 degrees.
